(19) United States
(12) Patent Application Publication
(10) Pub. No.: US 2014/0146635 A1
(43) Pub. Date: May 29, 2014

(54) Bulk Container With Integrated Dispensing Capability

(71) Applicant: Gustavo GUERRERO, Ventura, CA (US)

(72) Inventor: Gustavo GUERRERO, Ventura, CA (US)

(21) Appl. No.: 13/849,047

(22) Filed: Mar. 22, 2013

Related U.S. Application Data
(60) Provisional application No. 61/731,067, filed on Nov. 29, 2012.

(51) Int. Cl. B01F 15/02; B01F 15/00; B01F 15/06

(52) U.S. Cl. CPC B01F 15/0292; B01F 15/066; B01F 15/00175
USPC 366/142; 366/192; 366/146

(57) ABSTRACT

A bulk container with integrated dispensing capability has a container section that sits atop a riser. A cover protects the open top of the container, and a mixing attachment is secured inside the container. A dispenser attaches to the container and, using a valve, can enable or stop the flow of contents from the container to an adjacent receptacle. A thermally conductive insert mounts to the cover. The container serves as storage for food while the mixing attachment is used to stir foods to prevent their ingredients from separating and settling at the bottom. The thermally conductive insert is used to help regulate the temperature of the container contents. The riser provides clearance for the container and dispenser, and also can help regulate temperature similar to the thermally conductive insert. The design of the present invention allows container contents to easily be retrieved without having to move heavy bulk containers.

The current application claims a priority to the U.S. Provisional Patent application Ser. No. 61/731,067 filed on Nov. 29, 2012.

### FIELD OF THE INVENTION

The present invention relates generally to a container. More specifically, the present invention is a container for use in restaurants that is funnel shaped with stifling, temperature regulation, and flow control mechanisms which eliminates the need to remove heavy containers from shelves.

### BACKGROUND OF THE INVENTION

In the food restaurant industry mass storage of foods is required. A common method of storing large quantities of food is placing the food in large containers. Large polycarbonate plastic containers are common items in food facilities. The most common bulk food storage container shapes and sizes are round and square shaped and are 18 and 22 quart size capacity. Food law requires that all foods be stored off the floor, so in most cases these bulk food containers are stored on metro wire rack shelving. Wire racks are used in both dry food storage areas and also in walk in coolers. Current practices seen in food establishments are that these containers are filled to close to capacity then placed on metro wire rack shelving for storage. When a person needs to get items in the food container they must pull down the heavy food filled container to retrieve the necessary amount of food, then place container back on shelf. This requires lots of strength and effort. It is common practice to get a small bowl or utensil to retrieve food out of these large containers, and employees leaving these small items directly in these foods in the bulk containers. Leaving these items in the foods is dangerous and contaminates all the food in the container. Scooping foods out of these bulk containers also leaves the metro wire racks soiled from food falling out in the process of scooping. Employees utilize this practice because it is too difficult to pull down the large container for only a small amount of food necessary.

It is therefore an object of the present invention to provide a funnel shaped bulk container made of food safe plastic. It is a further object of the present invention to provide stirring, flow control, and temperature control mechanisms for the bulk container. It is a further object of the present invention to eliminate the need to move heavy bulk containers to access their contents. It is a further object of the present invention to eliminate the need to use utensils to retrieve foods from the bulk container.

### BRIEF DESCRIPTION OF THE DRAWINGS

FIG. 1 is a perspective view of the present invention.

FIG. 2 is a front internal view of the present invention.

FIG. 3 is a side internal view of the present invention.

FIG. 4 is an exploded side internal view of the present invention.

FIG. 5 is a top view, with the cover removed, of the present invention.

FIG. 6 is a perspective view of the riser of the present invention.

FIG. 7 is a perspective view of the dispenser of the present invention.

FIG. 8 is bottom perspective view of the cover of the present invention.

FIG. 9 is a side view of variant design of the dispenser of the present invention.

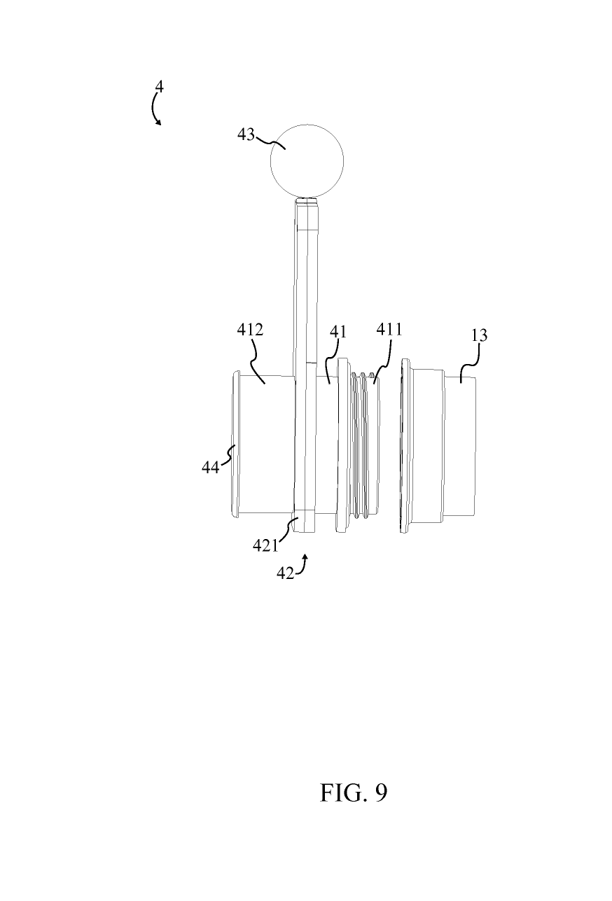

### DETAIL DESCRIPTIONS OF THE INVENTION

All illustrations of the drawings are for the purpose of describing selected versions of the present invention and are not intended to limit the scope of the present invention.

The present invention is a storage and dispensing apparatus with integrated means to manage the temperature of the stored contents. The present invention is additionally capable of regulating the temperature of stored contents. The present invention comprises a container 1, a cover 2, a riser 3, a dispenser 4, a thermally conductive insert 5, and a thermometer 6. The container 1 serves as storage for various contents and provides a space that allows for the mixing and temperature regulation of stored contents. The cover 2 is place above the container 1, preventing debris from entering the container 1 and creating a sanitary environment. The cover 2 also provides a connection point for the thermally conductive insert 5. The container 1 sits atop the riser 3, which serves as a support for the container 1. The dispenser 4 attaches to the container 1 and provides an outlet for the stored contents of the container 1. The thermally conductive insert 5 is suspended inside the container 1, acting to chill or warm the container 1 contents. The thermometer 6 is secured to the container 1 and provides a means for monitoring the temperature of the container 1.

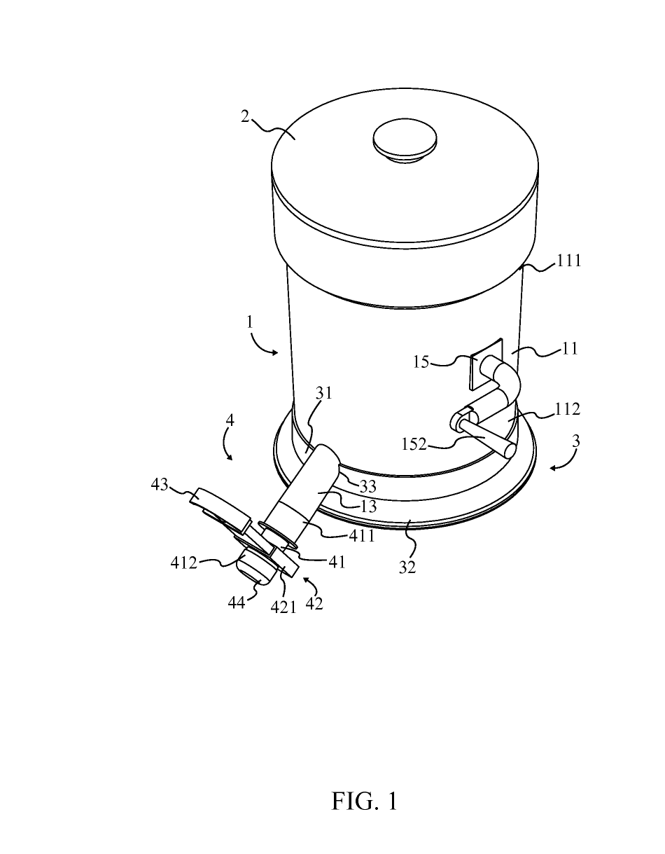

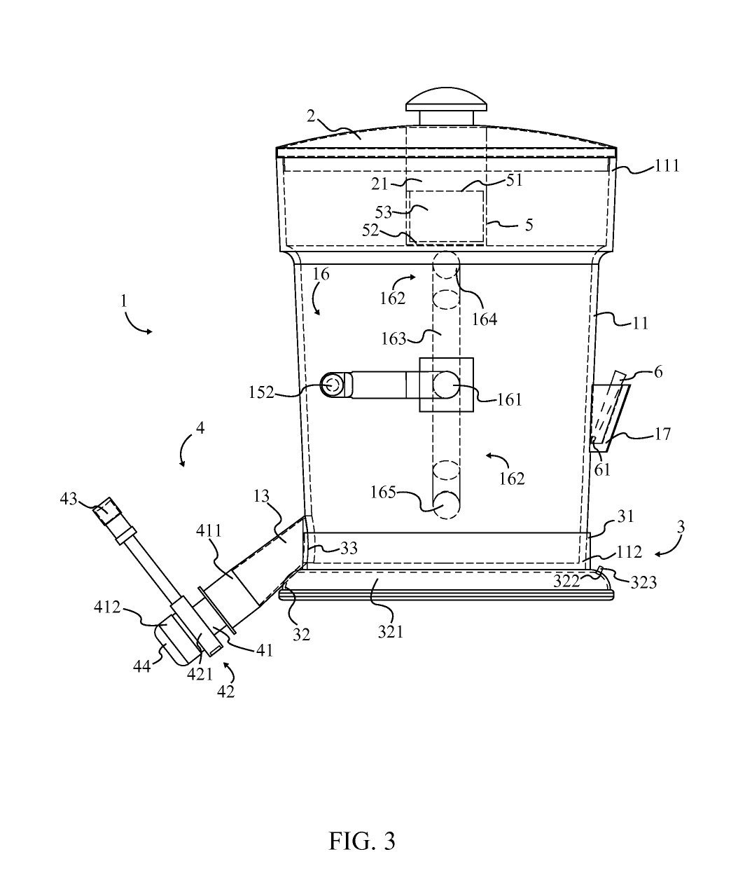

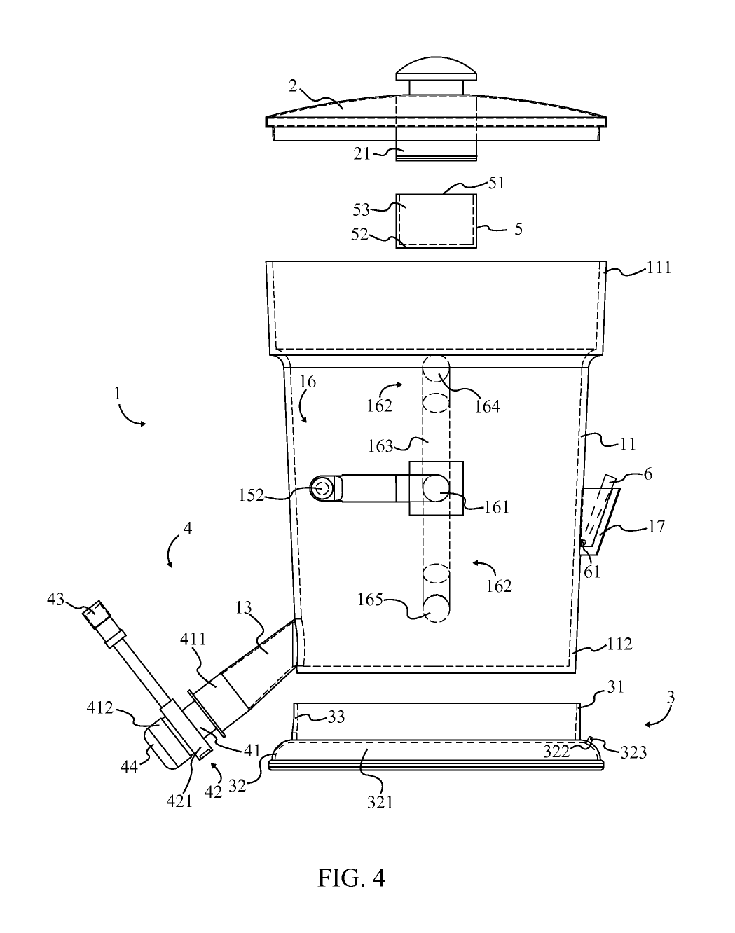

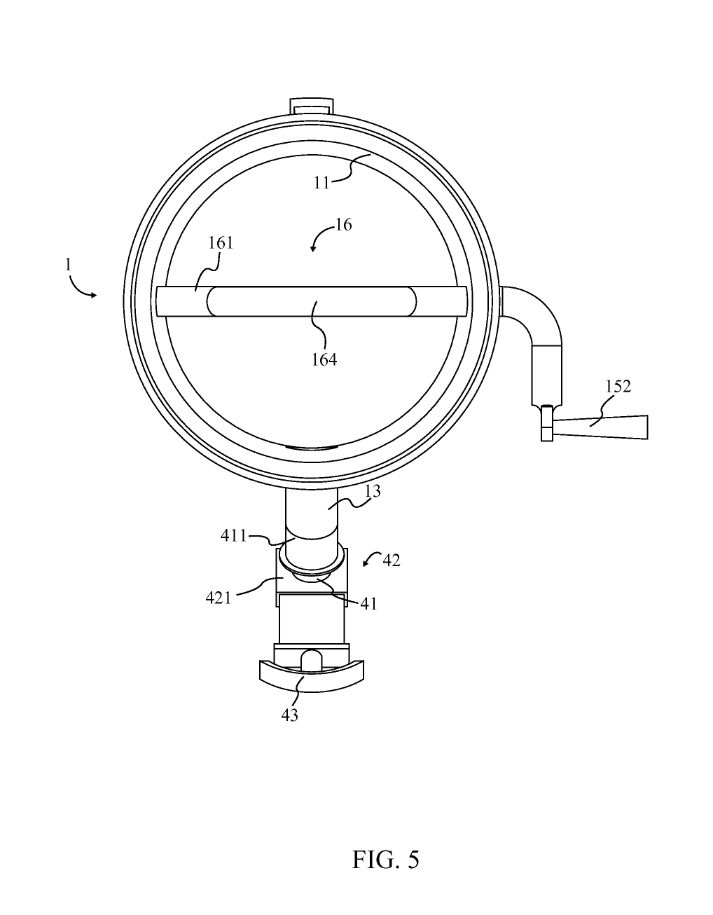

The container 1, illustrated in FIG. 1-FIG. 5, provides the storage, mixing, and temperature regulation functions of the present invention. The container 1 comprises a container wall 11, an interior volume 12, a flow pipe 13, a first receptacle housing 14, a second receptacle housing 15, a mixing attachment 16, and a pocket 17. The container 1 is formed by the container wall 11, which itself comprises a top end 111 and a base end 112. The container wall 11 is sloped from top end 111 to the base end 112, with the top of the container wall 11 being wider than the base end 112 of the container wall 11. The sloped nature of the container wall 11 helps to prevent contents from sticking to the walls; the tapered design funnels contents towards the base of the container 1. The space formed within the container wall 11 and the base serves as the interior volume 12. Contents of the container 1 occupy this interior volume 12, prior to being dispensed. Connected to the base end 112 is the flow pipe 13. The flow pipe 13 is a channel that connects the interior volume 12 with the dispenser 4. Contents in the interior volume 12 travel through the flow pipe 13 into the dispenser 4. The flow pipe 13 is connected to the bottom section of the container 1 since gravity is what enables the contents to be pulled through the flow pipe 13; if the flow pipe 13 was positioned at the top section, the majority of contents would be stuck within the interior volume 12, unable to pass through the flow pipe 13. The flow pipe 13 is also angled, which optimized the passage of contents. An angled flow pipe 13 allows gravity to pull the contents through the flow pipe 13. Positioned on the sides of the container wall 11 are the first receptacle housing 14 and the second receptacle housing 15. These first receptacle housing 14 and the second receptacle housing 15 are positioned on opposite sides of the container wall 11. The positioning of the first receptacle housing 14 and the second receptacle housing 15 is important, as they allow for the operation of the mixing attachment 16, which itself is attached between the two housings.

In the preferred embodiment the container 1 is cylindrical in shape. In other embodiments different shapes could be used for the container 1. A cylindrical shape is still preferable since rounded edges and lack of corners reduces the chances of the contents becoming stuck in corners or edges, which could interrupt the flow of contents to the flow pipe 13. Such stuck particles also are difficult to clean, in part due to the confined areas in which they are most likely to accumulate. While the container 1 itself may be constructed from a variety of materials, the selected material will be sturdy, cost-effective, and safe for use with food products. The preferred material is polycarbonate BPA free plastic. Potentially, the container wall 11 can be built to have insulating properties, helping to maintain the temperature of the contents stored inside the container 1.

The first receptacle housing 14 comprises a first hub 141, while the second receptacle housing 15 comprises a second hub 151 and a crank 152. The first hub 141 is positioned within the first receptacle housing 14 and the second hub 151 is positioned within the second receptacle housing 15. The hubs are designed so that they can rotate independent of the receptacle housings. The rotational capability of the first hub 141 and the second hub 151 allows for subsequent rotation of the mixing attachment 16. The crank 152 is placed outside the container wall 11, adjacent to the second receptacle housing 15. The crank 152 is connected to the second hub 151, such that turning the crank 152 causes the second hub 151 to rotate. The crank 152 provides an easily accessible and ergonomic means for a user to rotate the mixing attachment 16. The positioning of the crank 152 allows a user to mix the contents of the container 1 without having to remove the cover 2 from the container 1, helping to prevent contamination of the contents.

In the preferred embodiment bearings will be used for the first hub 141 and the second hub 151. The first receptacle housing 14 and the second receptacle housing 15 will be accessible from the exterior of the container 1, allowing the bearings to easily be serviced and replaced.

The mixing attachment 16, which comprises a shaft 161 and a mixing body 162, is secured between the two hubs. The shaft 161 is connected at opposite ends to the first hub 141 and the second hub 151; resultantly, the shaft 161 is free to rotate along with the first hub 141 and the second hub 151. The mixing body 162 comprises a rod 163, a first arc member 164, and a second arc member 165. The mixing body 162 is connected to the shaft 161, which allows the mixing body 162 to rotate along with the shaft 161. The rotation of the mixing body 162 is what enables a user to mix up contents stored in the interior volume 12. The rod 163 bisects the shaft 161, such that the intersection of the rod 163 and the shaft 161 is centrally positioned interior to the container wall 11. The first arc member 164 and second arc member 165 are connected to the rod 163, positioned at opposite ends of the rod 163. When the mixing attachment 16 is rotated, the rod 163, first arc member 164, and second arc member 165 revolve about the shaft 161, passing through and mixing the contents of the container 1 as the shaft 161 is rotated. The shaft 161 itself, which serves as the axis of rotation for the mixing attachment 16, does not mix food as it simply rotates in place. The combination of the first receptacle housing 14, the second receptacle housing 15, and the mixing attachment 16 provide the function of mixing the contents stored in the interior volume 12.

To secure the mixing attachment 16 to the first hub 141 and the second hub 151 a variety of solutions may be implemented. In one embodiment, a tension rod can be used as the shaft 161 of the mixing attachment 16. The tension rod may be compressed to allow it to be placed in the interior volume 12. Once the tension rod is aligned with the first hub 141 and the second hub 151, a user allows a spring in the tension rod to return to equilibrium, pushing either end of the tension rod into the first hub 141 or the second hub 151. This allows for an inexpensive, simple, and quick method of engaging and disengaging the mixing attachment 16 with the first hub 141 and the second hub 151. This is just one potential method of securing the mixing attachment 16; in yet another embodiment latches and shaft grooves could be provided on the first hub 141 and the second hub 151. This would allow the mixing attachment 16 to be placed in the shaft groove and locked down with the latch. Other embodiments are possible as well, as long as they provide a method to secure the mixing attachment 16 to the first hub 141 and the second hub 151.

The pocket 17 is positioned on the exterior of the container wall 11. The pocket 17 is designed to receive the thermometer 6, with an opening placed on the top side of the pocket 17. The thermometer 6 can be placed in the pocket 17, providing an easily accessible gauge of the temperature of the container 1 and its contents.

In the preferred embodiment the pocket 17 is a simple opening and holder on the side of the container wall 11. The pocket 17 is a basic component that allows the thermometer 6 to be held against the container 1 in order to measure temperature. In other embodiments the pocket 17 may be replaced by a piece with similar functionality. Potential replacements include hooks or clamps, which can be used to suspend the thermometer 6 at the side of the container wall 11. Other similar components can be implemented as long as they meet the functionality of holding the thermometer 6 adjacent to the container wall 11. In addition to securing the thermometer 6, the pocket 17, hooks, or clamps could be used to store and secure various other items, such as labels, caps, or cloths.

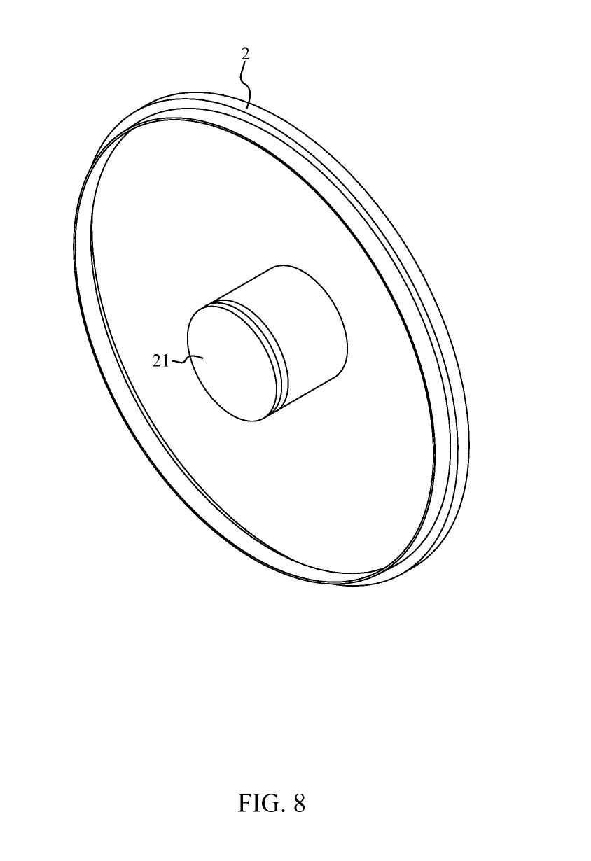

Shown in FIG. 1-FIG. 4 and FIG. 8, the cover 2 that is placed atop the container 1 comprises a mount point 21. The mount point 21 is positioned on the bottom face of the cover 2, such that the mount point 21 is within the container wall 11 when the cover 2 is on the container 1. The cover 2 is designed to attach to the top of the container 1, sealing the interior volume 12 off and preventing unwanted debris from falling into the container 1. The cover 2 preferably has a flat top, allowing the top to be used as a storage surface for other items.

In the preferred embodiment, the cover 2 secures to the container 1 by means of a lip. An insert wall of the cover 2 slides into the container 1, adjacent to the container wall 11. The lip overhangs the top edge of the container wall 11, preventing the cover 2 from falling into the interior volume 12. In other embodiments different attachment methods can be employed; for example, a plurality of latches could be positioned around the cover 2. Such latches can engage with the exterior of the container wall 11, using pressure to secure the cover 2 to the container 1. Potentially, a handle can be connected to the top of the cover 2, allowing a user to easily move the cover 2 on and off of the container 1.

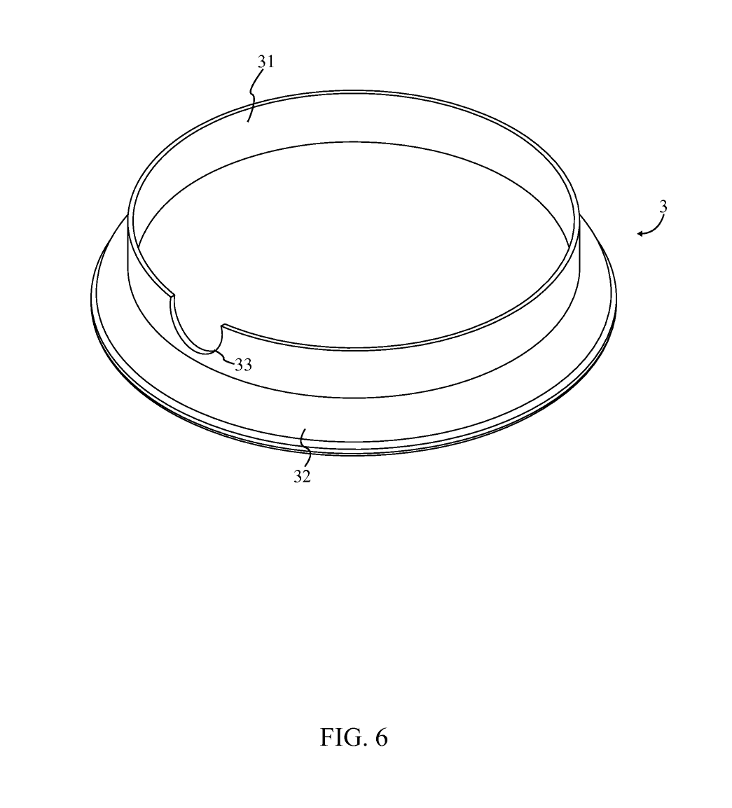

The riser 3 comprises a riser wall 31, a riser base 32, and a groove 33. Illustrations of the riser are provided in FIG. 1-FIG. 4 and FIG. 6. The riser wall 31 is connected to the perimeter of the riser base 32, extending upward and creating an empty space interior to the riser wall 31. The riser base 32 and riser wall 31 combine to form a support for the container 1. The container 1 is placed such that the bottom of the container 1 sits on the riser base 32. The base end 112 of the container wall 11 is fitted between the riser wall 31, such that the riser wall 31 prevents the container 1 from shifting or moving during use. When the container 1 is placed on the riser 3, the riser wall 31 presses against the container wall 11, using friction to secure the container 1 in place. The groove 33 is cut into the riser wall 31 to provide space for the flow pipe 13. Without the groove 33 the flow pipe 13 would hit the riser wall 31, preventing the container 1 from properly resting on the riser base 32.

The riser base 32 itself comprises a riser chamber 321, a riser opening 322, and a riser cap 323. The riser chamber 321, formed inside the riser base 32, provides a small storage area and is intended to assist with temperature regulation of the container 1 contents. By placed chilled elements, such as cold water or ice cubes, into the riser chamber 321 the temperature of the adjacent container 1 can be lowered. Alternatively, if the container 1 needs to be kept warm, a heated element like simmering water can be placed in the riser chamber 321 to raise the temperature of the adjacent container 1. The riser opening 322, which cuts a hole from the riser base 32, provides access to the riser chamber 321 and allows the riser chamber 321 to be filled or emptied, as necessary. To prevent the elements inside the riser chamber 321 from leaking out, a riser cap 323 is provided to seal the riser opening 322.

In the preferred embodiment the riser 3, similar to the container 1, is cylindrical in nature. The riser wall 31 should be slightly sloped to match the tapering of the container wall 11. In other embodiments where the container 1 is of a non cylindrical shape, the riser 3 should be of an accommodating shape. For example, if the container wall 11 is rectangular rather than cylindrical, the riser 3 should also have a rectangular shape. The riser opening 322 is preferably positioned on a side surface of the riser base 32, making it easier to refill and less likely to leak. Though the riser opening 322 could be positioned on the bottom of the riser base 32, this would require the riser 3 to be removed from a counter or other surface to be refilled or emptied. In addition, a bottom placed riser opening 322 would be more prone to leaks. Potentially, notches could be connected to the exterior of the riser 3, allowing the riser 3 to be anchored, strapped down, or otherwise secured to a wire shelf or other surface that the riser 3 rests on. In this embodiment, the notches serve as connection points for the anchors or straps.

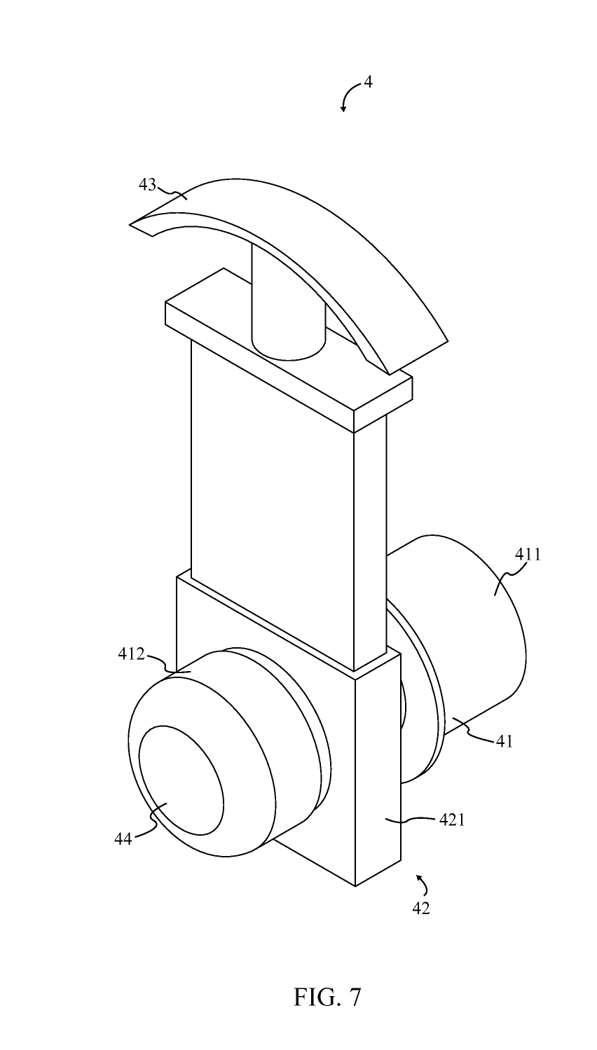

Depicted in FIG. 1-FIG. 5 as well as FIG. 7, the dispenser 4, which serves as an outlet for the contents of the container 1, comprises a dispensing tube 41, a valve 42, a valve handle 43, and a dispenser cap 44. The dispensing tube 41 comprises a first end 411 and a second end 412. The dispensing tube 41 connects to the flow pipe 13 at the first end 411, serving as a transition point from the container 1 to the dispenser 4. The second end 412, opposite the first end 411, is open and allows the contents of the container 1 to be transferred to a bowl or other receptacle positioned below the second end 412. To control the flow of contents, a valve 42 is positioned in the dispensing tube 41. The valve 42 allows a user to block flow in the dispensing tube 41, which is the standard setting for storage. When a user needs some of the contents in the container 1, they can place the bowl below the dispensing tube 41, remove the dispenser cap 44, and open the valve 42, allowing the contents to flow out of the dispensing tube 41 and into the bowl. To manipulate the valve 42, a connected valve handle 43 is positioned just outside the dispensing tube 41. The valve handle 43 allows a user to open or close the valve 42 as desired. When the valve 42 is closed, preventing flow of contents, the dispenser cap 44 is placed over the second end 412 of the dispensing tube 41. This helps to protect the interior of the dispensing tube 41 from contamination by outside debris. The dispenser cap 44 also prevents leaks from any contents that passed the open valve 42 just prior to the valve 42 being closed; these contents, especially more viscous ones, can slowly flow down the dispensing tube 41 and drip out the open end 51. The dispenser cap 44 prevents such spills, helping to maintain a clean environment where the container 1 is stored.

In the preferred embodiment the valve 42 is a gate valve 421. In other embodiments a different type, such as a ball valve, could be used. Though a wide variety of valves 42 can be implemented, basic types such as the gate valve 421 are excellent options as they are simple, reliable, and low cost. The present invention does not require a complex valve 42 to control the flow of contents through the dispensing tube 41. To cover 2 the dispensing tube 41, the dispenser cap 44 may be attached by a variety of means. As with the valve 42, the best methods of attachment will be simple, durable, and inexpensive. Providing matching threads on the dispenser cap 44 and the dispensing tube 41 to enable the dispenser cap 44 to be screwed into the dispensing tube 41. A simpler option is using an interference fit to secure the dispenser cap 44 to the dispensing tube 41. A number of methods are possible as long as the dispenser cap 44 can be secured to the dispensing tube 41 to prevent loose contents from leaking onto the floor, counter, or whatever surface is below the dispenser 4.

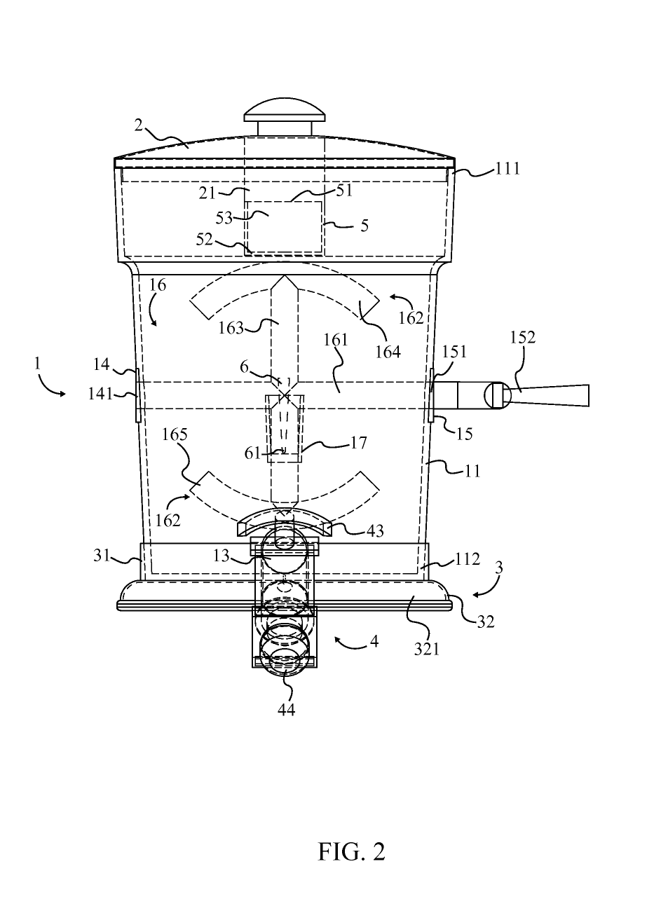

Providing a additional means of temperature regulation is the thermally conductive insert 5, as seen in FIG. 2-FIG. 4. The thermally conductive insert 5 comprises an open end 51, a closed end 52, and an insert chamber 53. The insert chamber 53 is positioned within the body of the thermally conductive insert 5 and accessed through the open end 51. The closed end 52 serves as a bottom of the insert chamber 53. The insert chamber 53 functions similarly to the riser chamber 321. Hot or cold elements can be placed in the insert chamber 53. When the thermally conductive insert 5 is mounted to the cover 2 and placed within the container 1, it will accordingly warm or cool the container 1 contents. These elements are placed in the insert chamber 53 through the open end 51. The thermally conductive insert 5 attaches to the mount point 21 so that when the cover 2 is atop the container 1 the thermally conductive insert 5 is suspended within the interior volume 12.

In the preferred embodiment the thermally conductive insert 5 attaches to the mount point 21 at the open end 51. This attachment seals the insert chamber 53, preventing the elements inside the insert chamber 53 from leaking into the interior volume 12. Though the thermally conductive insert 5 could be mounted at a different point, this would require an additional component to seal the open end 51; if the open end 51 is left exposed then there is a possibility that the elements inside the insert chamber 53 could spill and contaminate the contents of the container 1. The thermally conductive insert 5 should be short enough that it does not interfere with the mixing attachment 16; this allows for the mixing attachment 16 and the thermally conductive insert 5 to be used simultaneously. Though a taller thermally conductive insert 5 may be used, it will require removal of the mixing attachment 16 prior to being placed in the interior volume 12.

To measure provide a gauge of content temperature the thermometer 6 is placed in the pocket 17. The thermometer 6, which can be seen in FIG. 2-FIG. 5, comprises a temperature sensor 61. The thermometer 6 should be placed so that the temperature sensor 61 is in direct contact with the outside container wall 11. The helps provide the most accurate temperature reading possible. A gripping surface of the thermometer 6 allows a person to hold, move, and otherwise adjust the thermometer 6 without touching and interfering with the temperature sensor 61. The thermometer 6 also comprises a display screen which is positioned on the thermometer 6 body. The display screen should be large enough to be easily read, as well as positioned such that it may be seen even while the thermometer 6 is secured in the pocket 17.

In the preferred embodiment the thermometer 6 measures the temperature of the outside container wall 11. That is, the thermometer 6 measures the temperature of the container 1 itself rather than the contents. This is done because if the thermometer 6 is placed in the interior volume 12, it will not be visible from the exterior of the container 1. As a result, a person would need to remove the cover 2 to read the temperature, reducing the convenience of the thermometer 6. Placing the thermometer 6 in the interior volume 12 also introduces another potential source of contamination to the container 1 contents. In another embodiment, the thermometer 6 could be integrated into the container wall 11. Sensors could be placed through the container wall 11, with the aggregate temperature being reported on a display. For the best usability, the display would also be integrated into the container wall 11, facing away from the container 1. Resultantly, the temperature of the container 1 contents is easily observed. However, this embodiment would require a power source for the integrated thermometer 6. The power source would add bulk and cost to the container 1. As with other components, this and other alternative embodiments may be used as long as the function of the thermometer 6 is provided. As long as the thermometer 6 display is easily read from the exterior of the container 1, a number of alternative embodiments are consistent with the intended function of the present invention.

The present invention is preferably used for food storage. The container 1 provides space and mixing capability for stored food. The riser 3 lifts the container 1 off of a surface in order to provide clearance for the dispenser 4. The dispenser 4 provides an outlet, enabling or preventing the flow of food from the container 1 into a separate receptacle. The cover 2 protects the stored food and provides an attachment point for the thermally conductive insert 5. The thermally conductive insert 5, as well as the riser 3, provides a means of regulating the temperature of the stored food. In the preferred embodiment the present invention is used to keep stored food cool, though it is equally feasible to use the present invention to keep stored foods warm. While the preferred embodiment employs a single interior volume 12, alternative embodiments can partition the interior volume 12 into sections. Each section can be used to hold a different food type. In these other embodiments, each section would require its own flow pipe 13, dispenser 4, mixing attachment 16, hub, and thermometer 6. Due to the partitioned nature each individual mixing attachment 16 would have to be secured to a single hub. While any number of sections may be created, using more than four sections becomes difficult due to size and space requirements.

Though the preferred embodiment describes the thermally conductive insert 5 as being attached to the cover 2, in other embodiments the thermally conductive insert 5 can be placed in the interior volume 12 and be secured to the first hub 141 and the second hub 151. In these other embodiments the thermally conductive insert 5 provides the same function; the difference from the preferred embodiment is how the thermally conductive insert 5 is attached. To allow for this alternative attachment, the thermally conductive insert 5 would need to include a first attachment point and a second attachment point, positioned on opposite ends of the thermally conductive insert 5. As a result, the open end 51 would become closed and an insert opening would be positioned along the surface of the thermally conductive insert 5, providing access to the insert chamber 53. As with the preferred embodiment, the specific attachment method can vary, with tension rods again being simple and effective attachment methods. Though there would be no need to rotate the thermally conductive insert 5, providing an insert cap would recommended to prevent leakage of the elements in the thermally conductive insert 5. While attaching the thermally conductive insert 5 to the first hub 141 and the second hub 151 is possible, it precludes simultaneous use of the mixing attachment 16 and the thermally conductive insert 5. For this reason, the preferred embodiment attaches the thermally conductive insert 5 to the cover 2.

The components and arrangement of the present invention allow for easy bulk storage and dispensing of foods. The present invention also allows for keeping stored foods cool or warm, and provides a means for quickly gauging the temperature of the stored food. In the case of foods that have a tendency to settle, the present invention is capable of mixing up the stored food to help prevent various ingredients from separating. Overall, the present invention provides a more efficient food storage apparatus and provides a more sanitary storage environment by eliminating the need for short cuts in accessing and dispensing the stored food.

Although the invention has been explained in relation to its preferred embodiment, it is to be understood that many other possible modifications and variations can be made without departing from the spirit and scope of the invention as hereinafter claimed.

What is claimed is:

1. A bulk container with integrated dispensing capability comprises:
a container;
a cover;
a riser;
a dispenser;
the container comprises, a container wall, a interior volume, a flow pipe, a first receptacle housing, a second receptacle housing, and a mixing attachment;
the container wall comprises a top end and a base end;
the riser comprises a riser wall, a riser base, and a groove;
the dispenser comprises a dispensing tube, a valve, and a dispenser cap;
the container being positioned atop the riser;
the dispenser being positioned adjacent to the flow pipe;
the top end and the base end being positioned opposite each other along the container wall;
the interior volume being positioned between the top end and the base end;
the interior volume being positioned interior to the container wall;
the flow pipe traversing through the container wall and into the interior volume adjacent to the base end;
the flow pipe being sealably attached to the dispensing tube; and
the valve being positioned within the dispensing tube.

2. The bulk container with integrated dispensing capability as claimed in claim 1 comprises:
the first receptacle housing comprises a first hub;
the second receptacle housing comprises a second hub and a crank;
the mixing attachment comprises a shaft and a mixing body;
the mixing body comprises a rod, a first arc member, and a second arc member;
the container wall being tapered from the top end towards the base end;
the first receptacle housing and the second receptacle housing being laterally positioned opposite each other around the container wall;
the first hub being rotatably engaged with the first receptacle housing;
the second hub being rotatably engaged with the second receptacle housing;
the first hub and the second hub being coincident with each other;
the crank being positioned outside the container wall adjacent to the second hub;
the crank being connected to the second hub;
the shaft being attached to the first hub and the second hub;
the rod being centrally connected to the shaft; and
the rod being perpendicular to the shaft.

3. The bulk container with integrated dispensing capability as claimed in claim 2 comprises:
the first arc member and the second member being positioned opposite each other along the rod; and
the first arc member and the second arc member being connected to the rod.

4. The bulk container with integrated dispensing capability as claimed in claim 1 comprises:
the riser base comprises a riser chamber, a riser opening, and a riser cap;
the riser chamber being positioned interior to the riser base;
the riser opening traversing through the riser base into the riser chamber;
the riser cap being sealably attached to the riser opening;
the riser wall being perimetrically connected to the riser base;
the base end being fitted within the riser wall, wherein the riser wall presses against the base end;
the groove being positioned on the riser wall; and
the flow pipe being positioned in the groove.

5. The bulk container with integrated dispensing capability as claimed in claim 1 comprises:
a thermally conductive insert;
the cover comprises a mount point;
the cover being attached to the container adjacent to the top end;
the cover being positioned atop the container;
the thermally conductive insert centrally traversing into the interior volume;
the thermally conductive insert comprises an open end, a closed end, and a insert chamber;
the mount point being centrally positioned on the cover;
the open end and the closed end being positioned opposite each other along thermally conductive insert;
the insert chamber traversing into the open end; and
the open end being attached to the mount point.

6. The bulk container with integrated dispensing capability as claimed in claim 1 comprises:
the dispenser further comprises a valve handle;
the dispensing tube comprises a first end and the second end;
the first end and the second end being positioned opposite each other along the dispensing tube;
the valve being positioned between the first end and the second end;
the valve handle being positioned outside the dispensing tube and adjacent to the valve;
the valve handle being engaged with the valve;
the first end being positioned adjacent to the flow pipe; and
the dispenser cap being attached across the second end.

7. The bulk container with integrated dispensing capability as claimed in claim 6 comprises:
the valve being a gate valve;
the gate valve traversing into the dispensing tube; and
the valve handle being connected to the gate valve opposite the dispensing tube.

8. The bulk container with integrated dispensing capability as claimed in claim 1 comprises:
a thermometer;
the container further comprises a pocket;
the thermometer comprises a temperature sensor;
the pocket being connected exterior to the container wall;
the thermometer being position within the pocket; and
the temperature sensor being in contact with the container wall.

9. A bulk container with integrated dispensing capability comprises:
a container;
a cover;
a riser;
a dispenser;
a thermally conductive insert;
the container comprises, a container wall, a interior volume, a flow pipe, a first receptacle housing, a second receptacle housing, and a mixing attachment;
the container wall comprises a top end and a base end;
the first receptacle housing comprises a first hub;
the second receptacle housing comprises a second hub and a crank;
the mixing attachment comprises a shaft and a mixing body;
the riser comprises a riser wall, a riser base, and a groove;
the dispenser comprises a dispensing tube, a valve, a valve handle, and a dispenser cap;
the container being positioned atop the riser;
the dispenser being positioned adjacent to the flow pipe;
the top end and the base end being positioned opposite each other along the container wall;
the interior volume being positioned between the top end and the base end;
the interior volume being positioned interior to the container wall;
the flow pipe traversing through the container wall and into the interior volume adjacent to the base end;
the flow pipe being sealably attached to the dispensing tube;
the valve being positioned within the dispensing tube;
the shaft being attached to the first hub and the second hub;
the riser wall being perimetrically connected to the riser base;
the base end being fitted within the riser wall, wherein the riser wall presses against the base end; and
the flow pipe being positioned in the groove.

10. The bulk container with integrated dispensing capability as claimed in claim 9 comprises:
the mixing body comprises a rod, a first arc member, and a second arc member;
the container wall being tapered from the top end towards the base end;
the first receptacle housing and the second receptacle housing being laterally positioned opposite each other around the container wall;
the first hub being rotatably engaged with the first receptacle housing;
the second hub being rotatably engaged with the second receptacle housing;
the first hub and the second hub being coincident with each other;
the crank being positioned outside the container wall adjacent to the second hub;
the crank being connected to the second hub;
the rod being centrally connected to the shaft;
the rod being perpendicular to the shaft;
the first arc member and the second member being positioned opposite each other along the rod; and
the first arc member and the second arc member being connected to the rod.

11. The bulk container with integrated dispensing capability as claimed in claim 9 comprises:
the riser base comprises a riser chamber, a riser opening, and a riser cap;
the riser chamber being positioned interior to the riser base;
the riser opening traversing through the riser base into the riser chamber;
the riser cap being sealably attached to the riser opening; and
the groove being positioned on the riser wall.

12. The bulk container with integrated dispensing capability as claimed in claim 9 comprises:
the cover comprises a mount point;
the cover being attached to the container adjacent to the top end;
the cover being positioned atop the container;
the thermally conductive insert centrally traversing into the interior volume;
the thermally conductive insert comprises an open end, a closed end, and a insert chamber;
the mount point being centrally positioned on the cover;
the open end and the closed end being positioned opposite each other along thermally conductive insert;
the insert chamber traversing into the open end; and
the open end being attached to the mount point.

13. The bulk container with integrated dispensing capability as claimed in claim 9 comprises:
the dispensing tube comprises a first end and the second end;
the first end and the second end being positioned opposite each other along the dispensing tube;
the valve being positioned between the first end and the second end;
the valve handle being positioned outside the dispensing tube and adjacent to the valve;
the valve handle being engaged with the valve;
the first end being positioned adjacent to the flow pipe; and
the dispenser cap being attached across the second end.

14. The bulk container with integrated dispensing capability as claimed in claim 13 comprises:
the valve being a gate valve;
the gate valve traversing into the dispensing tube; and
the valve handle being connected to the gate valve opposite the dispensing tube.

15. The bulk container with integrated dispensing capability as claimed in claim 9 comprises:
a thermometer;
the container further comprises a pocket;
the thermometer comprises a temperature sensor;
the pocket being connected exterior to the container wall;
the thermometer being position within the pocket; and
the temperature sensor being in contact with the container wall.

16. A bulk container with integrated dispensing capability comprises:
a container;
a cover;
a riser;
a dispenser;
a thermally conductive insert;
a thermometer;
the container comprises, a container wall, a interior volume, a flow pipe, a first receptacle housing, a second receptacle housing, a mixing attachment, and a pocket;
the container wall comprises a top end and a base end;
the first receptacle housing comprises a first hub;
the second receptacle housing comprises a second hub and a crank;
the mixing attachment comprises a shaft and a mixing body;
the mixing body comprises a rod, a first arc member, and a second arc member;
the cover comprises a mount point;
the riser comprises a riser wall, a riser base, and a groove;
the riser base comprises a riser chamber, a riser opening, and a riser cap;
the dispenser comprises a dispensing tube, a valve, a valve handle, and a dispenser cap;
the dispensing tube comprises a first end and the second end;
the thermally conductive insert comprises an open end, a closed end, and a insert chamber;
the thermometer comprises a temperature sensor;
the container being positioned atop the riser;
the dispenser being positioned adjacent to the flow pipe;
the top end and the base end being positioned opposite each other along the container wall;
the interior volume being positioned between the top end and the base end;
the interior volume being positioned interior to the container wall;
the flow pipe traversing through the container wall and into the interior volume adjacent to the base end;
the flow pipe being sealably attached to the dispensing tube;
the valve being positioned within the dispensing tube;
the shaft being attached to the first hub and the second hub;
the riser wall being perimetrically connected to the riser base;
the first hub being rotatably engaged with the first receptacle housing;
the second hub being rotatably engaged with the second receptacle housing;
the crank being connected to the second hub;
the cover being positioned atop the container;
the mount point being centrally positioned on the cover;
the open end being attached to the mount point;
the riser chamber being positioned interior to the riser base;
the groove being positioned on the riser wall;
the base end being fitted within the riser wall, wherein the riser wall presses against the base end;
the flow pipe being positioned in the groove;
the valve being positioned between the first end and the second end;
the valve handle being positioned outside the dispensing tube and adjacent to the valve; and
the valve handle being engaged with the valve.

17. The bulk container with integrated dispensing capability as claimed in claim 16 comprises:
the container wall being tapered from the top end towards the base end;
the first receptacle housing and the second receptacle housing being laterally positioned opposite each other around the container wall;
the first hub and the second hub being coincident with each other;
the crank being positioned outside the container wall adjacent to the second hub;
the rod being centrally connected to the shaft;
the rod being perpendicular to the shaft;
the first arc member and the second member being positioned opposite each other along the rod;
the first arc member and the second arc member being connected to the rod;
the riser opening traversing through the riser base into the riser chamber; and
the riser cap being sealably attached to the riser opening.

18. The bulk container with integrated dispensing capability as claimed in claim 16 comprises:
the cover being attached to the container adjacent to the top end;
the thermally conductive insert centrally traversing into the interior volume;
the open end and the closed end being positioned opposite each other along thermally conductive insert; and
the insert chamber traversing into the open end.

19. The bulk container with integrated dispensing capability as claimed in claim 16 comprises:
the first end and the second end being positioned opposite each other along the dispensing tube;
the first end being positioned adjacent to the flow pipe;
the dispenser cap being attached across the second end;
the valve being a gate valve;
the gate valve traversing into the dispensing tube; and
the valve handle being connected to the gate valve opposite the dispensing tube.

20. The bulk container with integrated dispensing capability as claimed in claim 16 comprises:
the pocket being connected exterior to the container wall;
the thermometer being position within the pocket; and
the temperature sensor being in contact with the container wall.
